(19) United States
(12) Patent Application Publication
(10) Pub. No.: US 2005/0003894 A1
(43) Pub. Date: Jan. 6, 2005

(54) Study aid with video motivation and method of use

(76) Inventors: Gregory A. Piccionelli, Westlake Village, CA (US); Michael M. Gerardi, Menifee, CA (US)

Correspondence Address: Michael M. Gerardi, Esq., 28876 Woodcrest Lake Drive, Menifee, CA, 92584, US

(21) Appl. No.: 10/822,213

(22) Filed: Apr. 9, 2004

Related U.S. Application Data
(60) Provisional application No. 60/462,373, filed on Apr. 11, 2003.

(51) Int. Cl. G06F 19/00; G06F 17/00

(52) U.S. Cl. 463/42

(57) ABSTRACT

A method of studying a subject includes the steps of opening an educational application that includes a plurality of questions pertaining to a subject; answering at least one question included in the educational application; and viewing a model removing an article of clothing when the question is answered correctly.

This application is based on Provisional U.S. Patent Application Ser. No. 60/462,373, filed Apr. 11, 2003, the entire disclosure of which is incorporated herein by reference.

### FIELD OF THE INVENTION

The present invention relates to a method of studying a subject, such as astronomy, physics, history, music, languages and the like.

### BACKGROUND OF THE INVENTION

Educational applications for use in studying an academic or other subject are known. Such applications, frequently embodied in portable storage media such as CD-ROMS, facilitate self-study by users at home, an office or other locations. These applications often include audio and/or video components; for example, applications for the study of languages often include audio files providing proper pronunciation, as well as video files illustrating situations in which particular phrases are useful. Furthermore, such educational applications can be accessed via a network, such as the Internet.

Self-study, however, may prove difficult for some users. More specifically, some users may require additional motivation beyond that provided by presently known educational applications in order to complete a course of self-study.

A need exists for a method of studying a subject which provides additional motivation for the student to continue in the course of study.

A need also exists for computer applications useful in practicing such methods, and for portable storage media embodying such applications.

### SUMMARY OF THE PREFERRED EMBODIMENTS

In accordance with one aspect of the present invention, there is provided a method of studying a subject that includes the steps of: opening an educational application that includes a plurality of questions pertaining to a subject; answering at least one question included in the educational application; and viewing a model removing an article of clothing when the question is answered correctly.

In particular embodiments, a plurality of questions are answered in sequence, and for each question answered correctly, the model removes a different article of clothing.

Other particular embodiments provide a choice of a plurality of models for viewing. In more particular embodiments, once one model has removed a final article of clothing, another model is selected for further viewing.

In additional particular embodiments, the model initially wears at least one article of clothing associated with the subject.

According to a first more specific embodiment, the educational application is opened on a central site via a network. The central site further includes a link to a model site that permits viewing a model, which in very specific embodiments is activated when the educational application is opened. Simultaneously with, or subsequent to, answering a question, a user also selects an article of clothing to be removed by the model when the question is answered correctly.

The central site, in certain embodiments, charges an access fee, for example, when first accessed or after a specified number of questions have been correctly answered. Alternatively, the central site requires a user to provide a value, for example, a purchase of a membership in a site on a network, a purchase of a service, a purchase of a good, provision of an e-mail address or acceptance of an advertisement. In other certain embodiments, access to the central site is controlled based on the physical location of the user's location, i.e., the site which is attempting to access the central site. In still other embodiments, a premium is provided after all of the plurality of questions in the educational application have been correctly answered.

According to another more specific embodiment, the educational application is opened on a storage medium provided by a user, for example a CD-ROM. After accessing the educational application and answering a question pertaining to the subject of the file, a user provides the answer to a central site via a network. In particular embodiments, the central site includes a link to a model site permitting a user to view a model, and this link is activated when the central site is accessed. As above, the user selects an article of clothing for removal by the model simultaneously with, or subsequent to, provision of an answer to a question.

In particular embodiments, the central site determines when the question is answered correctly, and provides the model site with an instruction for the model to remove the selected article of clothing.

According to a further more specific embodiment, the educational application includes a link to a model site on a network that permits viewing a model. In these embodiments, a user accesses the educational application on a storage medium, such as a CD-ROM, provided by a user. In very specific embodiments, the link to the model site is activated when the educational application is opened.

In very particular embodiments, the educational application further includes an application for determining when a correct answer is provided to a question included therein.

At the time a question is answered, or at a subsequent time, the user selects an article of clothing to be removed by the model when the question is answered correctly, and the application provides the model site with an instruction for the model to remove the selected article of clothing.

As with preceding embodiments, the model site can charge a fee or require provision of value for accepting answer submissions beyond a specified number, and also provide a premium when all questions have been answered correctly. Access to the model site can also, in other embodiments, be controlled based on the physical location of the user.

In accordance with another aspect of the present invention, there is provided a method of studying a subject that includes the steps of: opening an educational application that includes a plurality of questions pertaining to a subject, and a video file including images of at least one model removing at least one article of clothing; providing an answer to at least one question; selecting at least one article of clothing worn by a model whose images are included in the video file; and viewing at least a portion of the video file including images of the model removing the selected article of clothing when the correct answer is provided.

Applications for implementing the inventive methods, and portable storage media including such applications, are also provided.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating a general method according to the invention,

FIG. 2 is a flowchart illustrating an embodiment of the inventive method in which an educational application is located on a central site on a network,

FIGS. 3a-b are illustrations of exemplary display screens affording a user a choice of subjects for study according to embodiments of the inventive method,

FIG. 4 is an illustration of an exemplary display screen including a question for a user to answer, together with a view of a model on a model site and a selection of articles of clothing for the model to remove,

FIG. 5 is an illustration of an exemplary display screen notifying a user that a question has been answered correctly and displaying a model removing a selected article of clothing,

FIG. 6 is a flowchart illustrating a variant method according to the invention in which a user selects an article of clothing for removal by a model after being notified that a question has been answered correctly,

FIGS. 7-9 are illustrations of exemplary display screens useful with the method of FIG. 6,

FIG. 10 is a flowchart illustrating an alternative method according to the invention in which a user supplies an educational application and communicates with a central site, which in turn provides instructions to a model site when a question has been answered correctly,

FIG. 11 is a flowchart illustrating another alternative method according to the invention in which a user supplies an educational application which communicates directly, via a network, with a model site, and

FIG. 12 is a flowchart illustrating a further alternative method according to the invention in which a user employs an educational application that includes both questions pertaining to a subject and a video file containing images of a model removing articles of clothing.

### DETAILED DESCRIPTION OF THE PREFERRED EMBODIMENTS

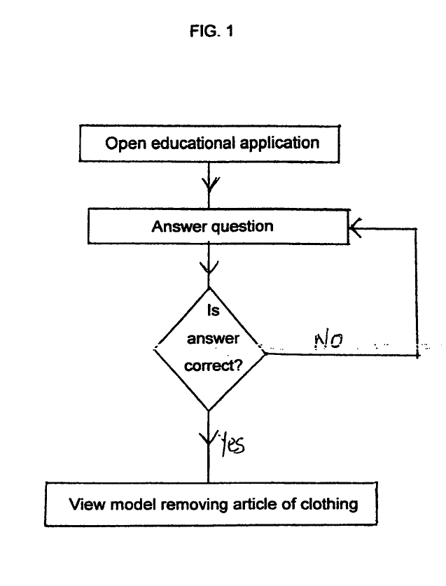

FIG. 1 illustrates a method according to the present invention in its most general aspect. A user opens an educational application that includes a plurality of questions pertaining to at least one subject, such as physics, astronomy, English, management, law, medicine, etc. More particular embodiments include a plurality of subjects; thus, a single educational application affords the user a choice of subjects for study.

After selecting a subject, the educational application displays a question pertaining to the subject to the user. In particular embodiments, the educational application selects a question at random from the plurality of questions pertaining to the subject. In other particular embodiments, the educational application displays an ordered sequence of questions pertaining to the subject. More specific embodiments track the questions that have been displayed and answered correctly in order to avoid repeating display of such questions.

After viewing the question provided by the educational application, the user answers the question. In more specific embodiments, the question is presented in multiple-choice format, and the user selects an answer using a cursor or other known means. In other more specific embodiments, the question is presented in fill-in format, and the user enters an answer via a keyboard or other known means.

Once the user has answered the question, a determination is made whether or not the answer is correct. This determination is made, in certain embodiments, by the educational application itself. In other embodiments, a separate application determines whether the answer is correct. In still other embodiments, a human referee determines whether the answer is correct.

When it is determined that the user has correctly answered the selected question, the user is enabled to view a model removing an article of clothing. This viewing can be enabled, for example, via a network, with the educational application providing an instruction via a network, such as the Internet, to a model site at which a model is present. When the model receives the instruction, she removes an article of clothing. According to some more specific embodiments, the model selects the article of clothing for removal. In other more specific embodiments, the user selects an article of clothing for removal by the model, and the model acts in accordance with the user's selection.

In certain embodiments, a plurality of models are available for viewing by the user. The user can select a specific model for viewing, or in the alternative, a model can be selected at random. A plurality of models is desirable when a user desired to answer a number of questions that exceeds the number of articles of clothing worn by a model to be viewed. When the first model has removed a final article of clothing, another model is selected for viewing; the user can continue to answer questions and select articles of clothing for removal by the next model.

Any number of articles of clothing can be worn by a model to be viewed according to the present invention. Likewise, any style of clothing can be worn by the model. In more particular embodiments, a model to be viewed initially wears at least one article of clothing associated with the subject selected by the user. For example, if the user selects chemistry as the subject, the model can initially wear a laboratory coat; if the user selects business administration, the model can initially wear business attire.

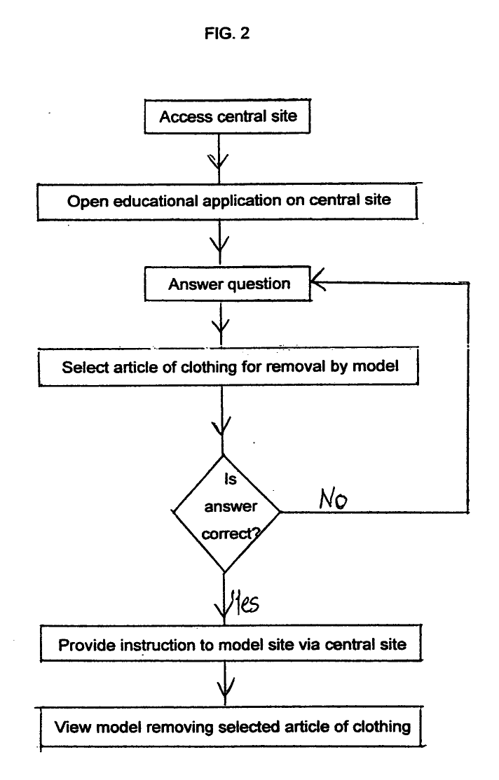

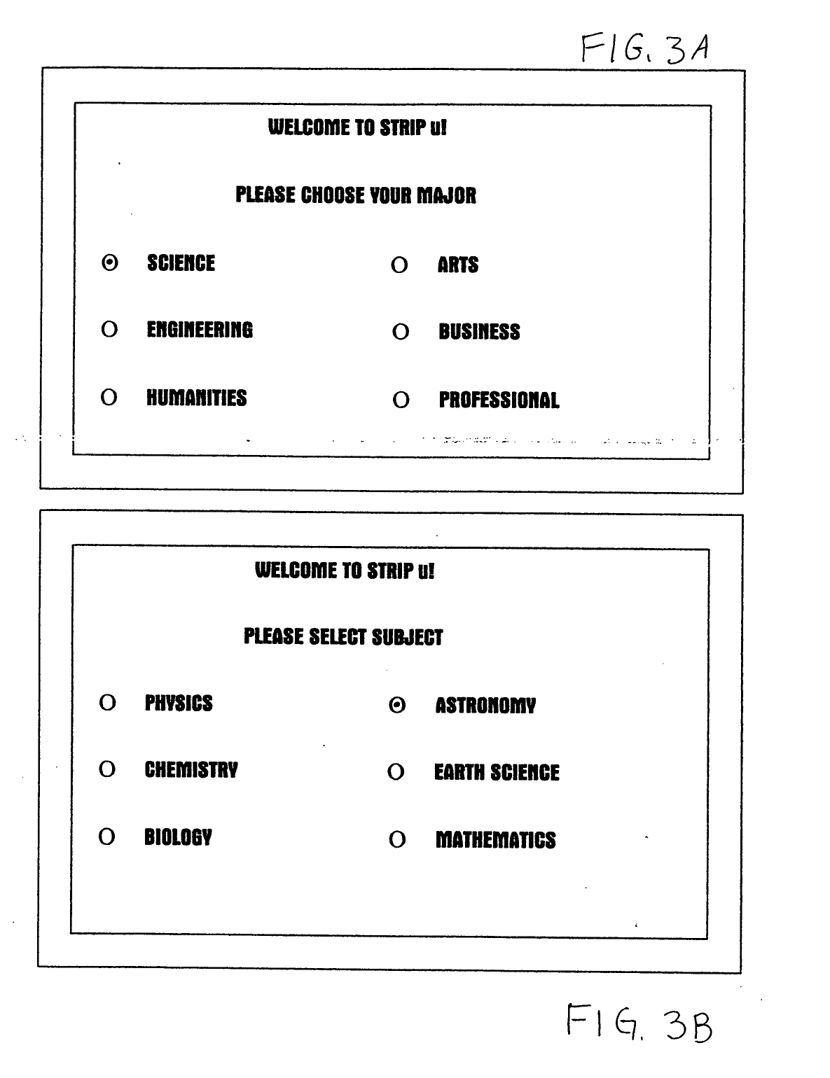

FIGS. 2-5 illustrate a first particular embodiment in which the educational application is located on a central site. A user first accesses the central site via a network, such as the Internet, and then opens the educational application. Once the educational application is opened, the user is afforded a choice of subjects for study. For example, the user can be provided with an initial choice of “majors”, i.e., groupings of related subject, and subsequently choices among more specific subjects within the major. Thus, as illustrated in FIG. 3a the user can first be afforded a choice among majors such as science, engineering, humanities, arts, business, and professional. After choosing a major, such as science, the user is then afforded a choice of more specific subjects within the major, such as physics, chemistry, biology, astronomy, etc. (see FIG. 3b). The specificity of the subject matter the user desires to study and answer questions about can be as detailed as desired. For example, more specific subjects under the general heading of arts can be provided, such as “Music”, “Art History”, and the like.

Having selected a subject for study, the user is then presented with a question pertaining to the subject. This question can be an initial question in a sequence (if the subject is being studied for the first time), another question in a predetermined sequence of questions, or a randomly selected question. As noted above, preferably the educational application tracks which questions (if any) have previously been answered by the user.

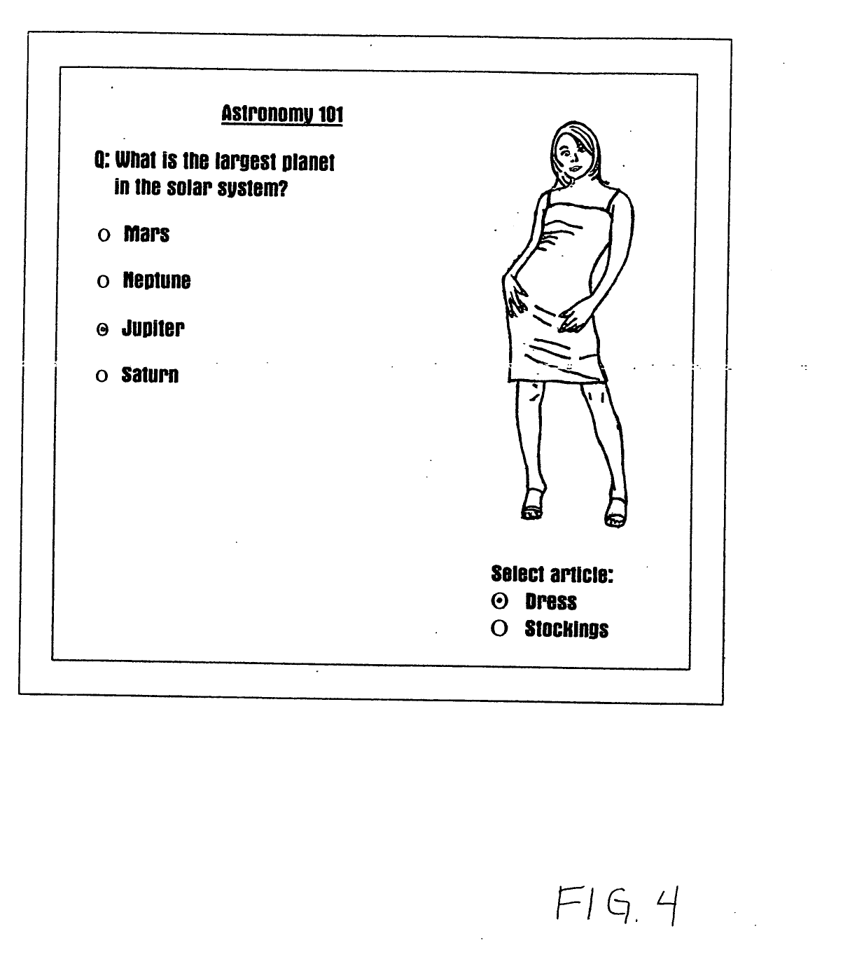

As shown in FIG. 4, a question is presented to the user in multiple-choice format. The user selects a desired answer using a mouse, keyboard or other known means. On the same screen, a box is opened in which an image of a model at a model site is displayed. The user is also provided with a selection of articles of clothing presently worn by the model, and selects an article of clothing for removal by the model when the question is answered correctly.

The model site can be viewed, for example, by activating a link included in the educational application, or by a link located on the central site that is in turn activated by the educational application. The link to the model site can be activated when the educational application is opened, or at a subsequent time.

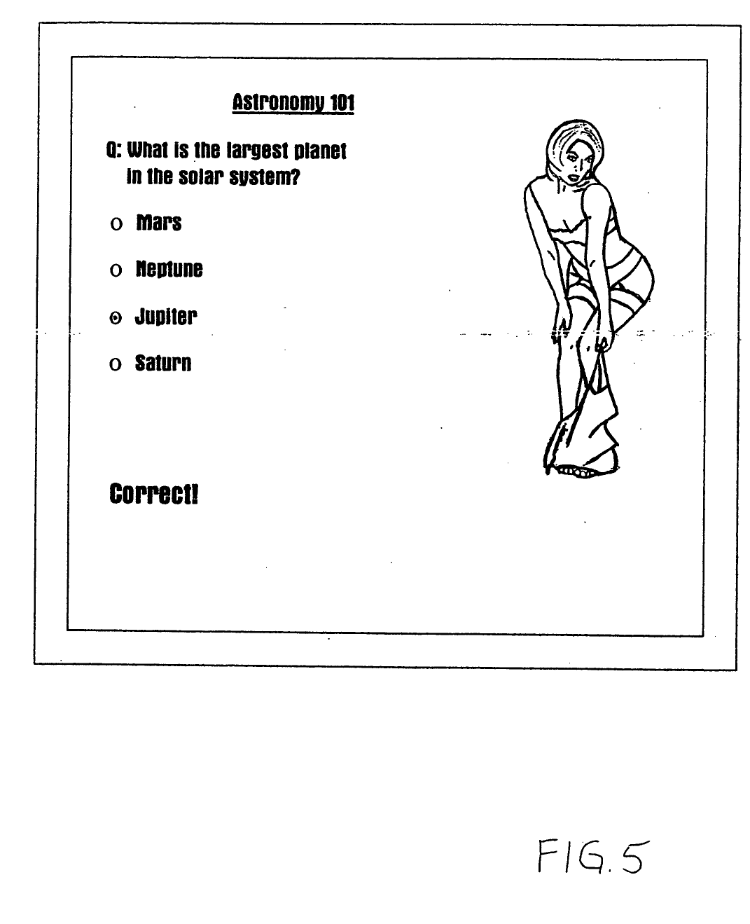

After the user selects an answer to the question, the answer is evaluated to determine whether or not it is the correct answer. This evaluation can be carried out by the educational application itself, or by another application located on the central site. When it is determined that the user has submitted the correct answer to the question, an instruction is provided to the model at the model site to remove the selected article of clothing. The instruction can be provided to the model site, for example, by the educational application itself or by another application located on the central site. As illustrated in FIG. 5, the educational application advises the user that the submitted answer was correct, and rewards the user with a viewing of the model removing the selected article of clothing.

It may be desirable is certain communities to limit access to the educational application and/or the model site utilized according to the present application. Accordingly, in particular embodiments, the physical location of the user is ascertained, for example by GPS means, and access to the educational application and/or the model site is controlled on the basis of the user's location. Such access control can be accomplished, for example, according to the methods disclosed in U.S. Pat. No. 6,154,172, to Piccionelli et al., the entire contents of which are incorporated herein by reference.

Hosting an educational application as described herein at a central site can generate revenue for the central site in particular embodiments of the invention. In such embodiments, the central site charges a fee for a user to access the educational application. The fee can be assessed, for example, each time the user desires to access the educational application. Alternatively, a user can provide some value to the central site, such as purchase of a membership in a site on a network, purchase of a service, purchase of a good, provision of an e-mail address, acceptance of an advertisement, or the like. Provision of the fee or value affords the user limited or unlimited access to the educational application. In still other alternative embodiments, a user is permitted to access the central site and open the educational application without charge, but after answering a predetermined number of questions pertaining to a subject, is required to provide a value before being authorized to answer any additional questions.

Once the user has correctly answered a predetermined number, or all, of the questions pertaining to the selected subject, particular embodiments of the inventive method provide the user with a premium. The premium can be, for example, a certificate or “diploma”, or in alternative embodiments a discounted or free admission to an establishment, such as a gentlemen's club, or a free or discounted performance by one or more of the models who were viewed by the user while the user was answering questions. In the latter alternative, the performance can be a performance which the user views in person at an entertainment establishment or other location, or a performance to be viewed on a site on a network, for example the same model site on which the user viewed the model(s) during use of the educational application. In particular embodiments, the educational application can provide a downloadable file enabling the user to print a coupon redeemable for the premium. Other methods for providing the user with a premium will be readily apparent to those skilled in the art and are intended to be encompassed by the present invention.

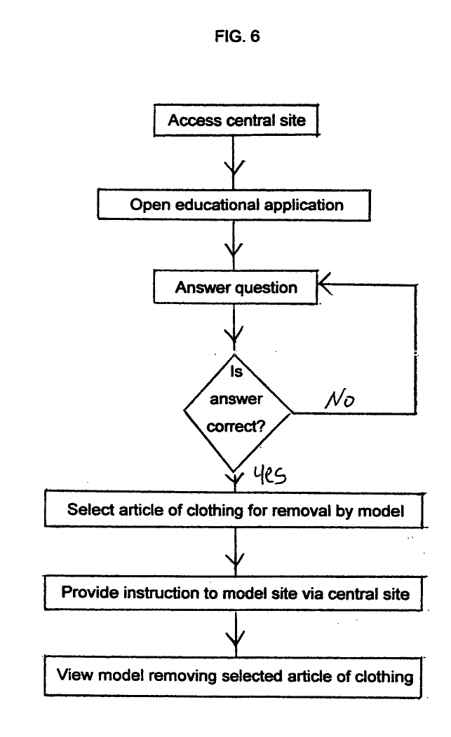

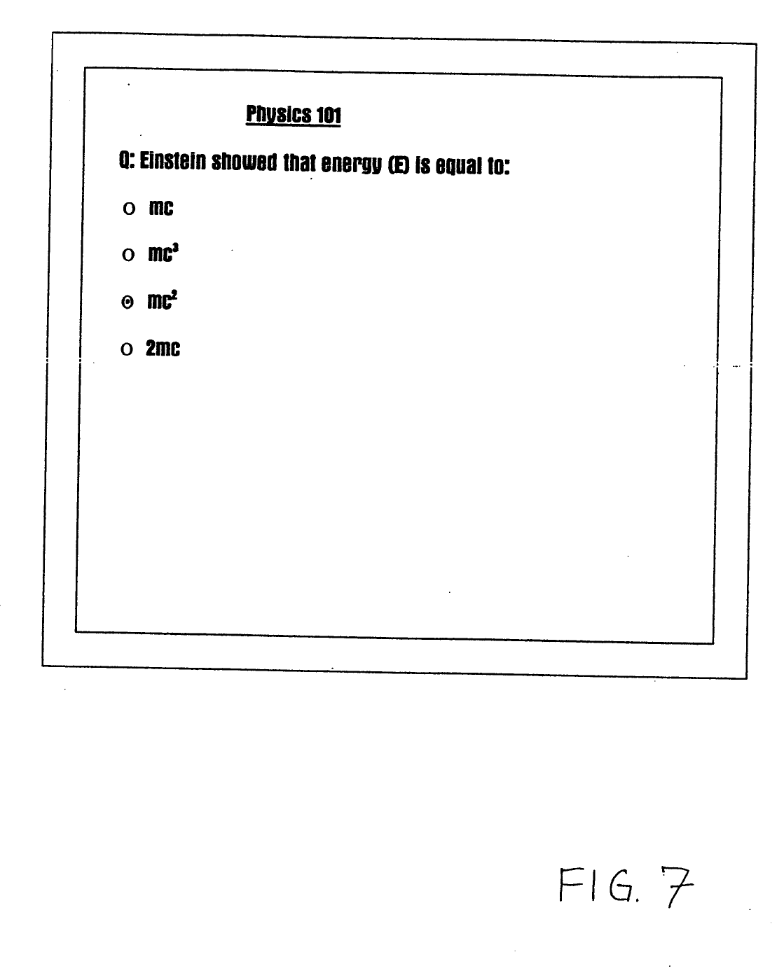

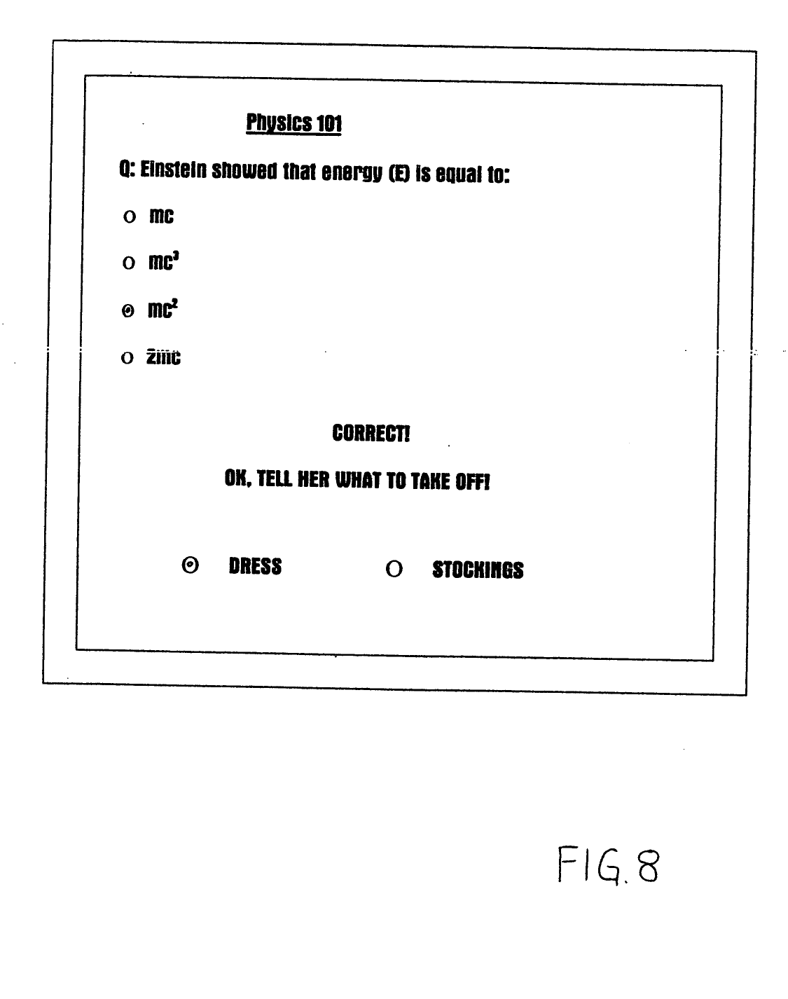

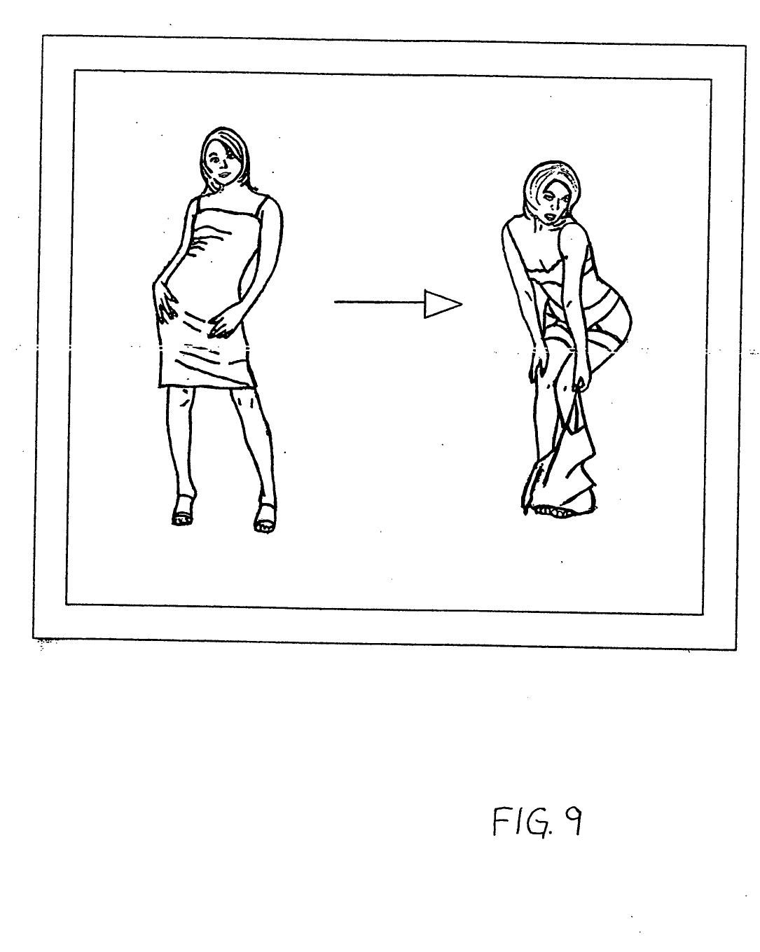

A variant of the foregoing method is illustrated in FIGS. 6-9. In this alterative, the user accesses the central site and opens the educational application in a manner similar to the foregoing method. In the alternative method, however, the user only answers a question pertaining to the selected subject (FIG. 7). Once it has been determined that the user has correctly answered the question, the educational application then informs the user that the answer was correct, and requests the user to select an article of clothing for removal by the model (FIG. 8). Once the user selects the desired article of clothing, an instruction is provided to the model site, in a manner similar to those described above. The user is then rewarded with a view of the model removing the selected article of clothing (FIG. 9).

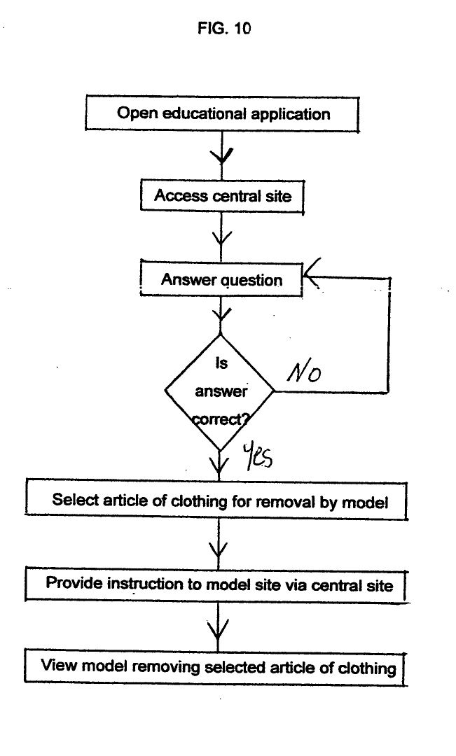

According to the foregoing methods, the educational application is located on a central site on a network, and optionally also includes a link to the model site. In an alternative embodiment illustrated in FIG. 10, the user opens an educational application which is stored on a CD-ROM or other storage medium, and transmits the answers to the questions pertaining to the selected subject to a central site, which includes a link to the model site. When the educational application (or alternatively, the central site) determines that a question has been answered correctly, an instruction is transmitted to the model site as described previously. The user then views the model removing a selected article of clothing.

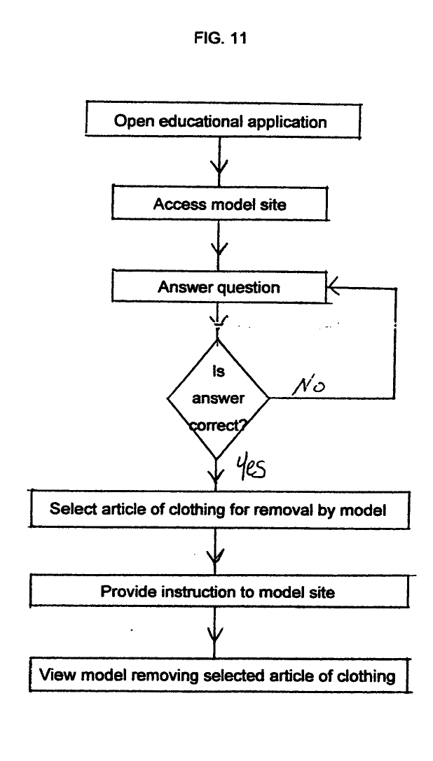

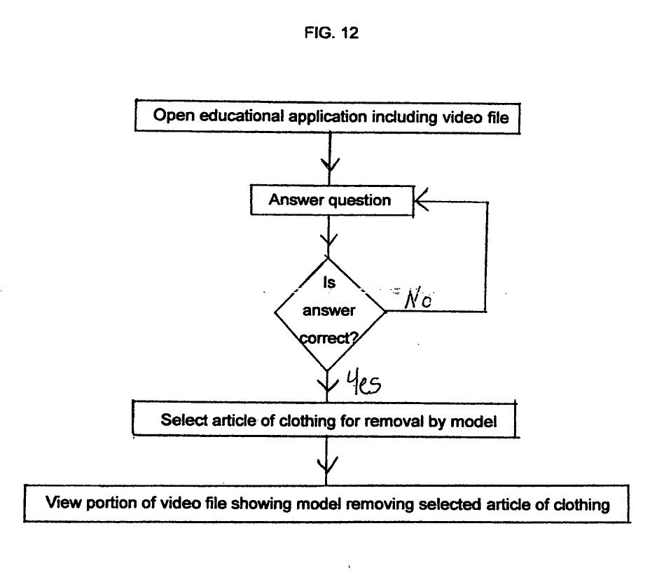

Additional embodiments of the inventive method (see FIG. 11) employ an educational application that is stored on a CD-ROM or other storage device, and that further includes a link to the model site which is activated directly by the educational application without recourse to a central site on a network. The link to the model site can be activated when the educational application is opened on the user's computer. Again, the user selects a subject, answers a question, and selects an article of clothing for removal by a model when the question is correctly answered.

The foregoing embodiments make use of a model site on which live models remove articles of clothing in response to instructions provided in real time by the educational application (or alternatively, a central site). Further alternative embodiments of the inventive method utilize an educational application which includes a model video file. This video file includes images of a least one model removing at least one article of clothing. According to such embodiments, a user opens the educational application on a personal computer, using a CD-ROM or other storage device on which the educational application is stored. The user selects a subject and answers a question in a manner similar to those described above. The educational application determines whether the answer provided by the user is correct. When the correct answer has been provided, the user selects an article of clothing for removal by a model. The educational application then accesses at least a portion of the video file including images of a model removing the selected article of clothing, and displays the portion of the video file to the user.

Computer applications for implementing embodiments of the inventive method include, for example, an educational application that includes a plurality of questions pertaining to a subject, together with means for providing answers to the questions to a model site and means for instructing a model at the model site to remove an article of clothing when a question has been answered correctly. Alternative computer applications include an educational application that includes a plurality of questions pertaining to a subject, and a video file of at least one model as described above. Such alternative applications further include means for receiving an answer to at least one question, means for selecting an article of clothing for removal, and means for accessing and displaying images from the video file showing a model removing the selected article of clothing. These applications can be provided on portable storage media, such as CD-ROMS.

1. A method of studying a subject comprising the steps of:
a) opening an educational application that includes a plurality of questions pertaining to a subject,
b) answering at least one question included in the educational application, and
c) viewing a model removing an article of clothing when the question in step b) is answered correctly.

2. The method of claim 1 comprising a plurality of sequential repetitions of steps b) and c).

3. The method of claim 2 wherein in each repetition of step c) a different article of clothing is removed.

4. The method of claim 2 wherein one of a plurality of models is selected for viewing in step c).

5. The method of claim 4 wherein another of the plurality of models is selected for viewing in step c) when the previously selected model has removed a final article of clothing.

6. The method of claim 2 wherein the model in step c) initially wears at least one article of clothing associated with the subject.

7. The method of claim 1 wherein step a) comprises opening the educational application on a central site via a network.

8. The method of claim 7 wherein the educational application further includes a link to a model site that permits viewing a model.

9. The method of claim 8 wherein the link is activated when the educational application is opened.

10. The method of claim 8 wherein step b) further comprises selecting an article of clothing to be removed by the model when the question is answered correctly.

11. The method of claim 10 wherein the educational application determines when the question in step b) is answered correctly.

12. The method of claim 11 wherein prior to step c) the educational application provides the model site with an instruction for the model to remove the selected article of clothing.

13. The method of claim 7 wherein a site accessing the central site has a physical location and wherein access to the central site is controlled based on the physical location of the accessing site.

14. The method of claim 7 wherein the central site requires a provision of value for access to the educational application.

15. The method of claim 7 comprising a plurality of sequential repetitions of steps b) and c).

16. The method of claim 15 wherein after a specified number of sequential repetitions of steps b) and c) the central site requires a provision of value prior to authorization of further sequential repetitions of steps b) and c).

17. The method of claim 15 wherein the central site requires a purchase of a membership in a site on a network, a purchase of a service, a purchase of a good, provision of an e-mail address, or acceptance of an advertisement.

18. The method of claim 15 wherein a premium is provided after a predetermined number of the plurality of questions in the educational application pertaining to the subject have been correctly answered.

19. The method of claim 18 wherein the premium comprises a discounted or free admission to an establishment.

20. The method of claim 18 wherein the premium comprises a discounted or free performance by a model viewed in step c), the performance to be viewed in person at an establishment or on a site via a network.

21. The method of claim 18 wherein a downloadable file is provided enabling printing of a coupon redeemable for the premium.

22. The method of claim 7 further comprising the steps of:
receiving a notification from the central site after step b) when the answer provided in step b) is correct and a request for selection of an article of clothing to be removed by a model, and
selecting an article of clothing to be removed by the model.

23. The method of claim 22 wherein the educational application provides the model site with an instruction for the model to remove the selected article of clothing.

24. A method of studying a subject comprising the steps of:
a) accessing a central site via a network,
b) opening on the central site an educational application that comprises
(i) a plurality of questions pertaining to a subject, and
(ii) a link to a model site permitting the user to view a model,
c) providing an answer to at least one said question,
d) instructing the model to remove an article of clothing when the educational application determines that the answer provided in step c) is correct, and
e) viewing the model removing the article of clothing upon determination by the educational application that the answer provided in step c) is correct.

25. A method of studying a subject comprising the steps of:
a) accessing a central site via a network,
b) opening on the central site an educational application that comprises a plurality of questions pertaining to a subject,
c) providing to the central site an answer to at least one said question,
d) receiving a notification from the central site when the answer provided in step c) is correct, together with a request for selection of an article of clothing to be removed by a model,
e) selecting an article of clothing in response to the request received in step d), and
f) viewing the model removing the selected article of clothing.

26. The method of claim 25 wherein step a) comprises opening the educational application on a storage medium provided by a user.

27. The method of claim 26 wherein the storage medium is a CD-ROM.

28. The method of claim 26 wherein step b) comprises providing the answer to a central site via a network, the central site including a link to a model site permitting a user to view a model.

29. The method of claim 28 wherein the link is activated when the central site is accessed.

30. The method of claim 28 wherein step b) further comprises selecting an article of clothing to be removed by the model when the question is answered correctly.

31. The method of claim 30 wherein the educational application determines when the question in step b) is answered correctly.

32. The method of claim 31 wherein prior to step c) the central site provides the model site with an instruction for the model to remove the selected article of clothing.

33. The method of claim 28 wherein a site accessing the central site has a physical location and wherein access to the central site is controlled based on the physical location of the accessing site.

34. The method of claim 28 wherein the central site requires a provision of value prior to accessing the site.

35. The method of claim 28 comprising a plurality of sequential repetitions of steps b) and c).

36. The method of claim 35 wherein after a specified number of sequential repetitions of steps b) and c) the central site requires a provision of value prior to authorization of further sequential repetitions of steps b) and c).

37. The method of claim 36 wherein the central site requires a purchase of a membership in a site on a network, a purchase of a service, a purchase of a good, provision of an e-mail address, or acceptance of an advertisement.

38. The method of claim 35 wherein a premium is provided after all of the plurality of questions in the educational application have been correctly answered.

39. The method of claim 38 wherein the premium comprises a discounted or free admission to an establishment.

40. The method of claim 38 wherein the premium comprises a discounted or free performance by a model viewed in step c), the performance to be viewed in person at an establishment or on a site via a network.

41. The method of claim 38 wherein a downloadable file is provided enabling printing of a coupon redeemable for the premium.

42. The method of claim 28 further comprising the steps of:
receiving a notification from the central site after step b) when the answer provided in step b) is correct and a request for selection of an article of clothing to be removed by a model, and
selecting an article of clothing to be removed by the model.

43. The method of claim 42 wherein the central site provides the model site with an instruction for the model to remove the selected article of clothing.

44. A method of studying a subject, the method comprising the steps of:
a) opening an educational application that comprises a plurality of questions pertaining to a subject,
b) providing to a central site via a network
i) an answer to at least one said question, and
ii) an instruction directing a model to remove an article of clothing when the central site determines that the answer so provided is correct, and
c) viewing via the network a model removing the article of clothing upon determination by the central site that the answer provided in step b) is correct.

45. A method of studying a subject, the method comprising the steps of:
a) opening an educational application that comprises a plurality of questions pertaining to a subject,
b) providing to a central site via a network an answer to at least one said question,
c) receiving a notification from the central site when the answer provided in step b) is correct, together with a request for selection of an article of clothing to be removed by a model,
d) selecting an article of clothing in response to the request received in step c), and
e) viewing via the network a model removing the selected article of clothing.

46. The method of claim 45 wherein the educational application further includes a link to a model site on a network that permits viewing a model.

47. The method of claim 46 wherein step a) comprises opening the educational application on a storage medium provided by a user.

48. The method of claim 47 wherein the storage medium is a CD-ROM.

49. The method of claim 47 wherein the link is activated when the educational application is opened.

50. The method of claim 46 wherein the educational application determines when a correct answer is provided to said at least one question included therein.

51. The method of claim 50 wherein step b) further comprises selecting an article of clothing to be removed by the model when the question is answered correctly.

52. The method of claim 51 wherein the educational application provides the model site with an instruction for the model to remove the selected article of clothing.

53. The method of claim 46 wherein a site accessing the model site has a physical location and wherein access to the model site is controlled based on the physical location of the accessing site.

54. The method of claim 46 wherein the model site requires a provision of value prior to accessing the site.

55. The method of claim 50 comprising a plurality of sequential repetitions of steps b) and c).

56. The method of claim 55 wherein after a specified number of sequential repetitions of steps b) and c) the model site requires a provision of value prior to authorization of further sequential repetitions of steps b) and c).

57. The method of claim 56 wherein the model site requires a purchase of a membership in a site on a network, a purchase of a service, a purchase of a good, or provision of an e-mail address.

58. The method of claim 55 wherein a premium is provided after all of the plurality of questions in the educational application have been correctly answered.

59. The method of claim 58 wherein the premium comprises a discounted or free admission to an establishment.

60. The method of claim 58 wherein the premium comprises a discounted or free performance by a model viewed in step c), the performance to be viewed in person at an establishment or on a site via a network.

61. The method of claim 58 wherein a downloadable file is provided enabling printing of a coupon redeemable for the premium.

62. The method of claim 50 further comprising the steps of:
receiving a notification from the educational application after step b) when the answer provided in step b) is correct and a request for selection of an article of clothing to be removed by a model, and
selecting an article of clothing to be removed by the model.

63. The method of claim 62 wherein the educational application provides the model site with an instruction for the model to remove the selected article of clothing.

64. A method of studying a subject, the method comprising the steps of:
a) opening an educational application that comprises
i) a plurality of questions pertaining to a subject, and
ii) a link to a model site on a network permitting the user to view a model,
b) providing an answer to at least one question included in the educational application,
c) instructing the model via the network to remove an article of clothing when the answer provided in step b) is correct, and
d) viewing the model removing the article of clothing upon determination by the central site that the answer provided in step b) is correct.

65. A method of studying a subject, the method comprising the steps of:
a) opening an educational application that comprises
i) a plurality of questions pertaining to a subject, and
ii) a video file including images of at least one model removing at least one article of clothing,
b) providing an answer to at least one question,
c) selecting at least one article of clothing worn by a model whose images are included in the video file, and
d) viewing at least a portion of the video file including images of the model removing the selected article of clothing when the answer provided in step b) is correct.

66. A computer application comprising
a) an educational application that includes a plurality of questions pertaining to a subject,
b) means for providing answers to the questions to a model site, and
c) means for instructing a model to remove an article of clothing when a question in the educational application is answered correctly.

67. A portable storage medium comprising the computer application of claim 66.

68. The portable storage medium of claim 67 which is a CD-ROM.

69. A computer application comprising
a) an educational application that comprises
i) a plurality of questions pertaining to a subject, and
ii) a video file including images of at least one model removing at least one article of clothing,
b) means for receiving an answer to at least one question,
c) means for selecting at least one article of clothing worn by a model whose images are included in the video file, and
d) means for accessing and displaying at least a portion of the video file including images of the model removing the selected article of clothing when the answer provided in b) is correct.

70. A portable storage medium comprising the computer application of claim 69.

71. The portable storage medium of claim 70 which is a CD-ROM.
